(19) United States
(12) Patent Application Publication
(10) Pub. No.: US 2011/0209335 A1
(43) Pub. Date: Sep. 1, 2011

(54) METHOD FOR MANUFACTURING INK JET CARTRIDGE

(75) Inventors: Hiroyuki Yamamoto, Kawasaki-shi (JP); Jun Hinami, Kawasaki-shi (JP); Takeshi Shibata, Yokohama-shi (JP); Hirotaka Miyazaki, Yokohama-shi (JP); Yoshiaki Kurihara, Kawasaki-shi (JP); Ryo Shimamura, Yokohama-shi (JP); Tomohiro Takahashi, Yokohama-shi (JP); Naoya Tsukamoto, Kawasaki-shi (JP); Tatsunori Fujii, Kawasaki-shi (JP); Masashi Ishikawa, Kawasaki-shi (JP)

(73) Assignee: CANON KABUSHIKI KAISHA, Tokyo (JP)

(21) Appl. No.: 13/019,649

(22) Filed: Feb. 2, 2011

(30) Foreign Application Priority Data
Feb. 26, 2010 (JP) 2010-041735

(51) Int. Cl. B23P 17/00

(52) U.S. Cl. 29/505

(57) ABSTRACT

A predetermined amount of an ink absorber, which is a fiber assembly in which intersections between fibers are not fused together, is charged into a compression and insertion apparatus. A rectangular parallelepiped-shaped insertion block is moved to an upper surface portion of the absorber, and one face of the ink absorber is pushed by a side plate. As such, a part excluding the part of the ink absorber which faces the side plate is compressed and surrounded. In this state, the ink absorber is compressed by the side plate. The ink absorber is inserted into a tank case by making a bottom plate slide, thereby opening the bottom face of the ink absorber and by moving down the insertion block.

### BACKGROUND OF THE INVENTION

1. Field of the Invention

The present invention relates to a method for manufacturing an ink jet cartridge used for an ink jet recording apparatus, and a method for manufacturing the ink jet cartridge in which an ink discharge device which discharges ink, and an ink storage portionink storage portion which stores ink to be supplied to the ink discharge device are integral with each other. Particularly, the present invention relates to a method for manufacturing an ink jet cartridge having a step of compressing and inserting an absorber including fibers to be arranged within an ink storage portion.

2. Description of the Related Art

Conventionally, it is usual that an ink jet cartridge used for an ink jet recording apparatus is designed such that the pressure within a tank case becomes a negative pressure with respect to an atmospheric pressure in order to maintain the ink supply performance to an ink jet recording head.

As a means which generates such a pressure (hereinafter referred to as a negative pressure), for example, a porous body, such as urethane sponge, or a fiber assembly including fibers made of resin is known.

In Japanese Patent Application Laid-Open No. H09-183236, an ink absorber using fibers of a core-sheath structure of polypropylene and polyethylene is described as an ink absorber using a fiber assembly including fibers made of resin. Specifically, an ink absorber is described which adopts polypropylene for the core and polyethylene for the sheath, and only the polyethylene is melted and intersections between the fibers are fused, using the difference between the melting points of the materials, thereby maintaining the shape retainability or the strength as the ink absorber.

Meanwhile, in recent years, expectations for materials or products in which the global environment, such as problems of greenhouse effect gases and waste, is taken into consideration has rapidly increased, and using global resources effectively (that is, recycling efficiency) is required.

However, it is difficult to clean the urethane sponge used for the negative-pressure generating member of the ink tank or the fiber assembly in which intersections between the fibers are bonded together, in every detail in order to be reused as a product again.

Additionally, in recent years, miniaturization of a main body of an ink jet printer has become necessary as a customer requirement, and how the ink jet cartridge is capable of being efficiently arranged within the main body of the ink jet printer has become important. That is, efficiently arranging the ink jet cartridge within the main body of the ink jet printer is required by providing a complicated ink jet cartridge shape. If the ink absorber using the urethane sponge as mentioned above or the ink absorber in which the fibers are fused together is applied, it is necessary to cut a mass of material of a certain shape into a complicated shape which suits an ink jet cartridge in advance. Accordingly, if an ink absorber is made in accordance with an ink jet cartridge of a complicated shape, the efficiency in the use of a material will deteriorate and costs will increase even more than previously. If an ink absorber is formed in a rectangular parallelepiped shape as is conventionally known in order to improve the efficiency in the use of a material and reduce costs, the dead space where ink is not stored will increase when the ink absorber is held within the ink jet cartridge. As a result, ink charging efficiency will deteriorate, the frequency of ink jet cartridge replacement will increase, and the printing cost (running cost) for printing per page will increase.

Therefore, compatibility of recycling efficiency and the degree of freedom in the shape of the ink jet cartridge is obtained not by applying the above-mentioned ink absorber in which intersections between fibers are fused together but the ink absorber in which intersections between fibers are not fused together. That is, the cleaning performance of the ink absorber improves after being used as a product, and reusing becomes easy. In addition, since the necessity for being cut into a complicated product shape is eliminated, the efficiency in the use of a material to be used to form an ink absorber improves, and it is possible to provide the ink absorber to a customer cheaply.

Additionally, as functions required for the ink absorber, there are two factors that ink is maintained at a negative pressure and leakage of the ink to the outside is reduced and that ink is efficiently supplied to the ink discharge device and the efficiency in the use of the ink within the ink absorber is improved.

If it is not possible to efficiently supply the ink which is maintained at a negative pressure in the ink absorber to the ink discharge device, it is impossible to use the ink with a large amount of ink remaining in the ink absorber, which will lead to an increase in the running cost. Thus, a method of improving the efficiency in the use of ink includes forming a density distribution in an ink absorber. A portion with a dense ink absorber has a strong capillary force compared to a portion with a coarse ink absorber. Therefore, by making the ink absorber of the portion corresponding to an ink supply portionink supply portion denser, it is possible to draw the ink distant from the ink supply portion closer to the ink supply portion, and it is possible to improve the efficiency in the use of ink.

As such a method, a method of cutting a mass of material in advance so that the volume of an ink absorber corresponding to an ink supply portion increases in the case of the ink absorber which is a porous body, and pushing the ink absorber using a lid of a container, thereby increasing the density of the ink absorber corresponding to the ink supply portion is described in Japanese Patent Application Laid-Open No. H08-224893.

Additionally, a method of performing needle punching in a state where the amount of the fibers corresponding to the ink supply portion is partially increased in the case of the ink absorber in which fibers are not bonded together, and entwining the fibers, thereby increasing the density of the ink absorber of the portion corresponding to the ink supply portion is described in Japanese Patent Application Laid-Open Nos. H08-224893 and H06-255121.

As described above, in order to make an improvement in recycling efficiency and an improvement in the degree of freedom in the ink cartridge shape compatible, an ink absorber in which intersections between fibers are not fused together is considered. Additionally, in order to efficiently use the ink which is maintained at a negative pressure in the ink absorber, it is necessary to make the density of the ink absorber near the ink supply portion high and make the density of the ink absorber distant from the ink supply portion coarse.

Although the method of forming the ink absorber of the porous body densely or coarsely is described in Japanese Patent Application Laid-Open No. H08-224893, a step of cutting a mass of material into a complicated shape which suits an ink jet cartridge is required in this case. Additionally, when an ink absorber mass of material is cut into a complicated shape, a surplus portion incapable of being used as an ink absorber will be generated in the mass of material. That is, the complicated cut-out step will increase the waste of material, and thus costs will increase.

Meanwhile, a method of forming an ink absorber in which fibers are not fused together densely or coarsely is described in Japanese Patent Application Laid-Open No. H06-255121. In detail, disclosed is a method of supplying fibers to a conveyor belt, changing the amount of the fibers to be supplied, performing needle punching in that state, and entwining the fibers, thereby holding a dense or coarse state, and then cutting and inserting the fibers. However, in this case, there is a concern that the steps are complicated and that dense or coarse distribution is upset due to the handling when the fibers are inserted after being cut because the fibers are not fused together.

Additionally, although improving the efficiency in the use of the ink in the ink absorber is disclosed in Japanese Patent Application Laid-Open Nos. H08-224893 and H06-255121, the method of maintaining ink at a negative pressure and reducing leakage of the ink to the outside, which is another function of the ink absorber, is not disclosed. According to the research of the present inventor, it has been proved that it is effective in terms of leakage of ink to make the capillary force small near a portion, such as an atmosphere communication portion, which communicates with the outside of an ink cartridge compared to other portions. Therefore, in order to reduce leakage of ink to the outside of the ink cartridge, it is desirable to make the vicinity of the atmosphere communication portion dense so that ink hardly moves.

### SUMMARY OF THE INVENTION

The invention has been made in view of the above problems. Specifically, the object of the invention is to provide a method for manufacturing an ink jet cartridge capable of simply and stably forming dense or coarse distribution in an ink absorber with no waste of an ink absorber material. Another object of the invention is to provide a method for manufacturing an ink jet cartridge capable of reducing leakage of ink from an ink cartridge.

In order to achieve the above objects, one aspect of the invention is a method for manufacturing an ink jet cartridge in which an ink absorber consisting of an assembly of the fibers which are not fused to each other and holding ink therein by the capillary force between fibers is housed in an ink storage portion which stores ink to be supplied to an ink discharge device which discharges ink. The manufacturing method includes compressing the ink absorber to provisionally mold the ink absorber; and inserting the provisionally molded ink absorber into the ink storage portion. The provisional molding compresses and surrounds a surface excluding a surface on the side of the part of the ink absorber where the capillary force is to be increased, using a compression plate, and finally compresses the surface on the side of the part of the ink absorber where the capillary force is to be increased, using a separate compression plate in the compressed and surrounded state.

According to the invention, it is possible to manufacture an ink jet cartridge through simple steps without generating waste material and having excellent efficiency in the use of ink, and to provide a manufacturing method of a cheap ink jet cartridge which is inexpensive and low in running cost. Additionally, it is also possible to provide a manufacturing method of an ink jet cartridge with reduced ink leakage.

Further features of the present invention will become apparent from the following description of exemplary embodiments with reference to the attached drawings.

### BRIEF DESCRIPTION OF THE DRAWINGS

FIGS. 1A and 1B are a schematic view and a sectional view of an ink jet cartridge in the invention.

FIGS. 2A, 2B, 2C, 2D and 2E are schematic views illustrating a manufacturing method of provisionally molding and inserting an ink absorber in a first embodiment of the invention.

FIGS. 3A, 3B and 3C are schematic views for describing compression of an ink absorber of a fiber assembly in which intersections between fibers are fused together.

FIGS. 4A, 4B and 4C are schematic views for describing compression of an ink absorber of a fiber assembly in which intersections between fibers are not fused together.

FIG. 5 is a schematic view for describing the density distribution of the ink absorber in the first embodiment of the invention.

FIGS. 6A and 6B are schematic views illustrating a manufacturing step of provisionally molding and inserting an ink absorber in a second embodiment of the invention.

FIG. 7 is a schematic view for describing the density distribution of the ink absorber in the second embodiment of the invention.

FIG. 8 is a schematic view for describing the heating step of the ink absorber in the second embodiment of the invention.

FIGS. 9A, 9B, 9C and 9D are schematic views illustrating a manufacturing step of provisionally molding and inserting an ink absorber in a third embodiment of the invention.

FIG. 10 is a schematic view for describing the density distribution of the ink absorber in the third embodiment of the invention.

FIG. 11 is a schematic sectional view of an ink jet cartridge to which a fourth embodiment of the invention is applied.

FIGS. 12A, 12B, 12C and 12D are schematic views illustrating a manufacturing step of provisionally molding and inserting the ink absorber in the fourth embodiment of the invention.

FIGS. 13A, 13B and 13C are sectional views for describing the density distribution of the ink absorber in the fourth embodiment of the invention.

### DESCRIPTION OF THE EMBODIMENTS

Preferred embodiments of the present invention will now be described in detail in accordance with the accompanying drawings.

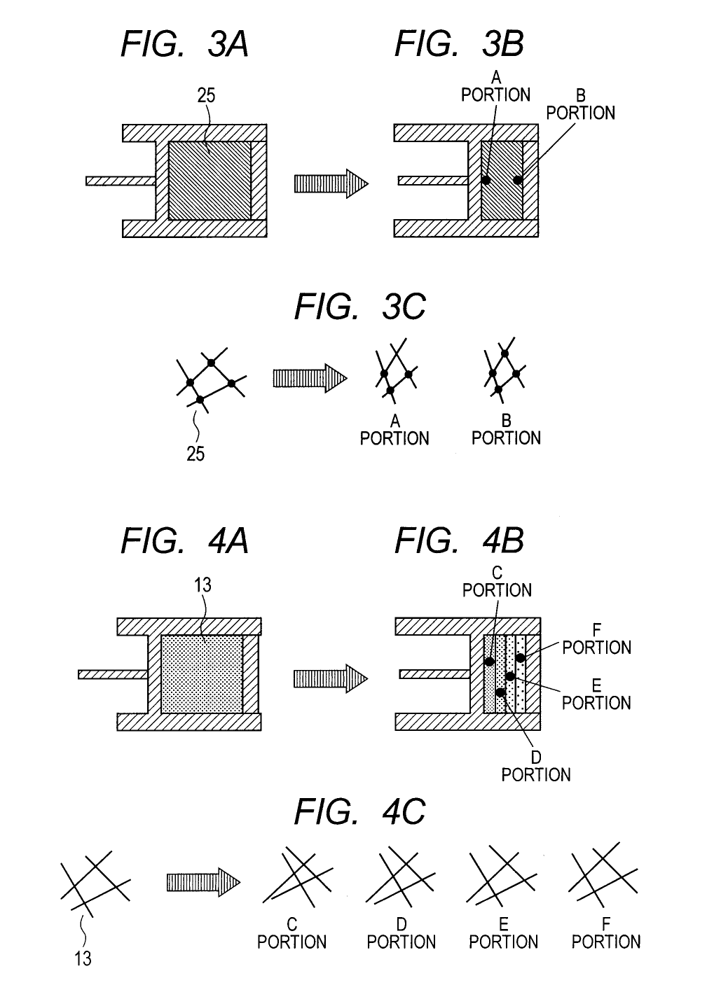

First, the density distribution formation in a case where an ink absorber has been compressed in FIGS. 3A to 4C will be described.

Schematic sectional views in a case where an ink absorber 25, including a fiber assembly in which fibers are fused together, has been compressed are illustrated in FIGS. 3A to 3C. The ink absorber 25 has a so-called spring structure in which fibers are mutually bonded. Hence, when the ink absorber 25 is put into a cylinder as illustrated in FIG. 3A and the ink absorber 25 is pushed by a piston, as illustrated in FIG. 3B, a force is transmitted from the pushing surface to the whole ink absorber, and the whole ink absorber is compressed. Therefore, since a density difference is not easily formed from a compression surface toward its opposite surface, as illustrated in FIG. 3C, a density difference is substantially not formed between a region (A portion) on the side of the compression surface and a region (B portion) on the side of its opposite surface.

In contrast, schematic sectional views in a case where an ink absorber 13 in which fibers are not fused together are illustrated in FIGS. 4A to 4C. Since fibers are not fused together in the ink absorber 13 in this case, individual fibers are able to move freely into gaps. Therefore, fibers of a compressed portion move into gaps. Since a force is absorbed as fibers move into gaps, the compressing force is not easily transmitted toward the opposite surface. Hence, as illustrated in FIG. 4B, the density of a region on the side of a compression surface (C portion) becomes high, and the density of a region (F portion) on the side of its opposite surface rarely change. Hence, as illustrated in FIG. 4C, a density difference is easily formed from a compression surface toward its opposite surface (in order of higher density; in order of C, D, E, and F portions), and a density is formed between a region (C portion) on the side of the compression surface and a region (F portion) on the side of its opposite surface.

### First Embodiment

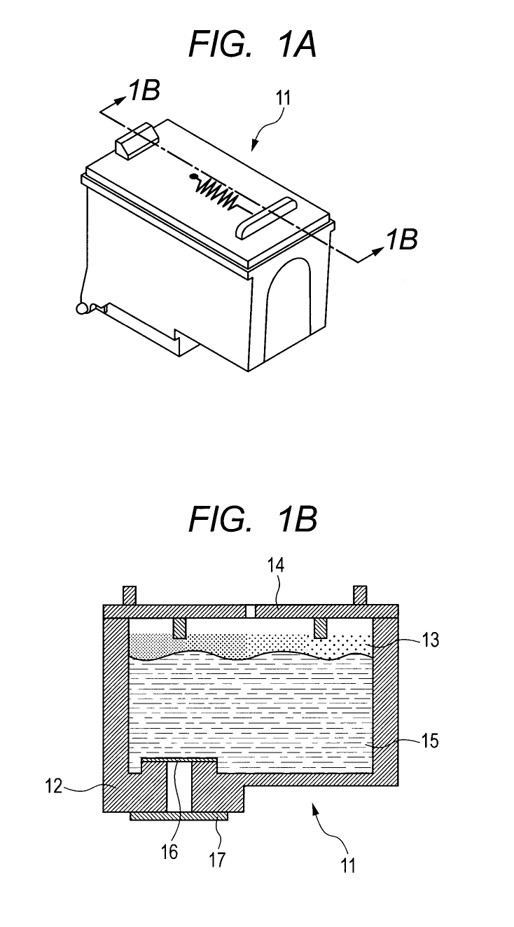

FIGS. 1A and 1B are a schematic view and a sectional view illustrating a first embodiment of an ink jet cartridge 11 manufactured by a manufacturing method of the invention. FIG. 1B is a sectional view taken along the line 1B-1B of FIG. 1A. The ink jet cartridge 11 includes an ink storage portion having a tank case 12 which stores ink, and a lid 14, and an ink discharge device 17. An ink absorber 13 which holds ink is housed in the tank case (container) of the ink storage portion, and the ink 15 filled into the ink absorber is supplied to the ink discharge device 17 fixed to the bottom of the tank case 12 via an ink supply portion 16. The ink discharge device 17 adopts a so-called ink jet type which has elements which generate heat energy, vibration energy, or the like which is available for droplet discharge. Additionally, the tank case 12 has a rectangular parallelepiped shape, and the ink supply portion 16 is disposed near a longitudinal end of a bottom face of the tank case.

The ink absorber 13 includes a fiber assembly in which intersections (hereinafter referred to as intersections between fibers) between fibers are not fused together. Although the material of the fibers which constitute the fiber assembly is appropriately selectable in consideration of ink-contact resistant properties and includes polyolefin, polyester, acrylonitrile, or the like, the material of the fibers preferably includes polyolefin having a chemically high restoring force. It is also possible to select fibers with a two-layer structure, such as a core-sheath structure which is generally used for the ink absorber. Specifically, even if different kinds of materials are selected such as using polypropylene (PP) for the core and polyethylene (PE) for the sheath, there is no problem. Since it is obvious that it is not necessary to fuse the intersections between fibers together, the material of the fibers may be a single material. PP single fibers are selected in the present embodiment. It is necessary to set a negative pressure suitable for the ink jet cartridge 11 as a function required for the ink absorber 13. This negative pressure is determined depending on the dimension of voids which exist within the ink absorber 13. That is, the ratio (hereinafter referred to as fiber density) of the weight of the fibers which exist in an ink holding portion to the volume of the ink holding portion formed in the tank case 12, and an average negative pressure is determined depending on the diameter of the fibers. The fiber density is appropriately selectable depending on the required negative pressure of each ink jet cartridge, and the average fiber density in the present embodiment was set to 12%. The diameter of the fibers is also appropriately selectable if negative-pressure characteristics are to be satisfied. In the present embodiment, 6.7 d tex was selected. Since the length of the fibers is not a factor which has an influence on negative-pressure characteristics, it is possible to appropriately select the length of the fibers depending on manufacturing handling. In the present embodiment, the length of the fibers is appropriately selectable if the length is greater than or equal to a length at which fibers are entangled. As a result of study, it became clear that a length of 6 mm or more is specifically required in order to maintain the shape because of entanglement between the fibers. In the present embodiment, fibers of 50 mm length were used from the viewpoint of entanglement between the fibers or shape retainability after being formed into an ink absorber.

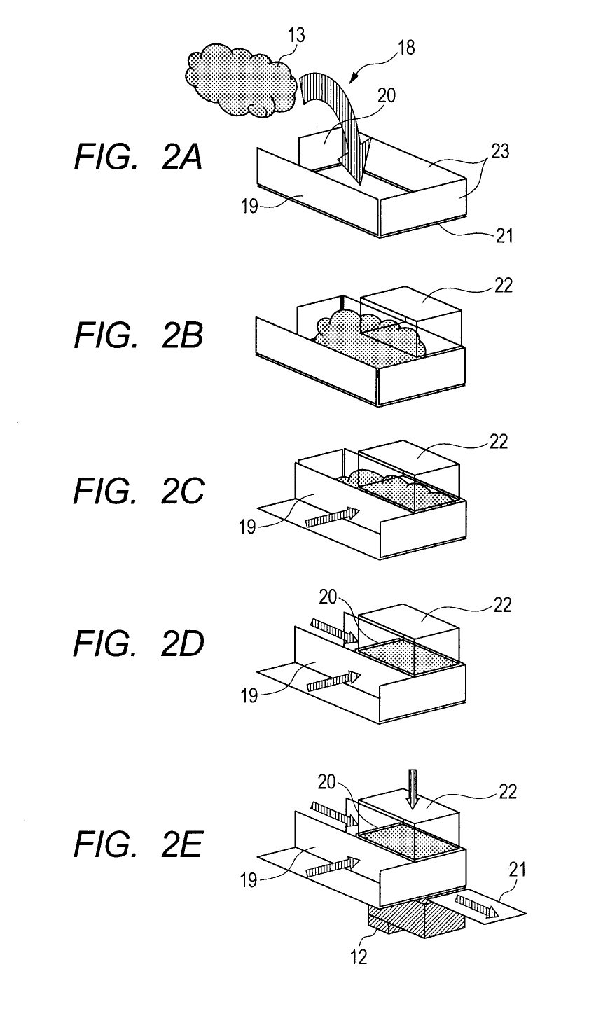

Schematic views of a first embodiment in the manufacturing method of the invention are illustrated in FIGS. 2A to 2E. First, as illustrated in FIG. 2A, a predetermined amount of the ink absorber 13, which is a fiber assembly in which intersections between fibers are not fused together, is charged into a compression and insertion apparatus 18. The amount of charging is determined depending on a desired negative pressure (fiber density) with respect to the volume or ink injection amount of the tank case. The compression and insertion apparatus 18 has a bottom plate 21, a right-angled fixing plate 23 which is vertically arranged at and fixed to the bottom plate 21, and a side plate 19 and a side plate 20 serving as a compression plate, which is freely movable while facing two plate portions, which constitutes a fixing plate 23 so as to form a right-angled portion. A concave space which allows the ink absorber 13 to be charged into the apparatus 18 is formed by the bottom plate 21, the fixing plate 23, the side plate 19, and the side plate 20.

Next, as illustrated in FIGS. 2B and 2C, a rectangular parallelepiped-shaped insertion block 22 is moved to an upper surface portion of the absorber 13, and one face of the ink absorber 13 is pushed by the side plate 19. At this time, since there is an escape space for the fibers in the direction of the side plate 20, the ink absorber is rarely compressed, and density distribution is rarely formed. As such, a surface excluding a surface on the side of the part of the ink absorber 13 which faces the side plate 20 is compressed and surrounded. In this state, the ink absorber 13 is compressed by the side plate 20 as illustrated in FIG. 2D. Since there is almost no escape space for the fibers by the fixing plate 23, the insertion block 22, the bottom plate 21, and the side plate 19, the ink absorber is compressed, and density distribution is formed from a face on the side of the side plate 20 toward its opposite face.

Next, as illustrated in FIG. 2E, insertion of the ink absorber 13 into the tank case 12 is completed by making the bottom plate 21 slide, thereby opening the bottom face of the ink absorber 13 and by moving down the insertion block 22.

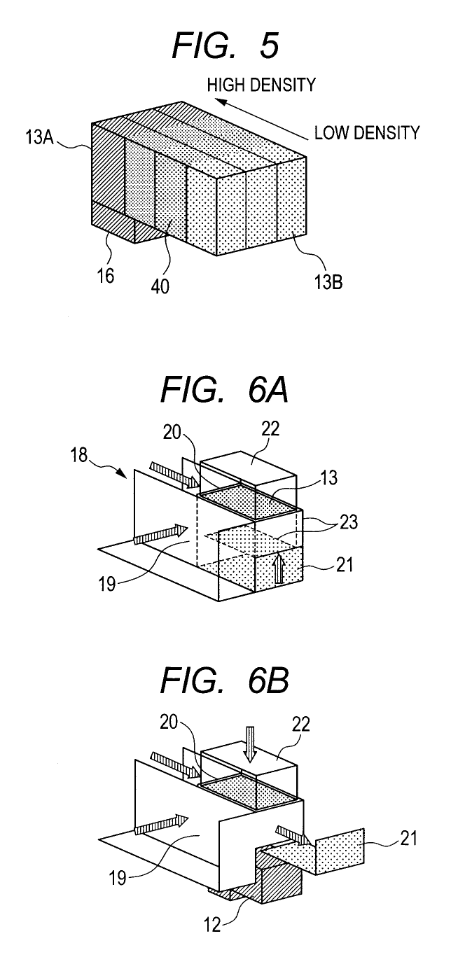

FIG. 5 is a schematic view illustrating the density distribution in a case where the ink absorber 13 has been compressed by the method illustrated in FIGS. 2A to 2E, and has been inserted into the ink storage portion. The density on the side of a face 13A corresponding to the side plate 20 which is finally compressed is the highest, and the density becomes lower in a direction toward a face 13B opposite to the above face. Thereby, the fiber density near the ink supply portion 16 illustrated in FIG. 1B becomes relatively high within the ink absorber 13, and it is consequently possible to draw ink 15 close to the ink supply portion 16. Therefore, the efficiency in the use of the ink 15 improves. A face 40 is provided on the side of the side plate 19.

Additionally, as illustrated in FIG. 8, if the ink absorber 13 is inserted all at once into a heating container 24 after being compressed, and is heated in that state, intersections between fibers in a state where density distribution is formed are fused together. Then, even in a case where handling is performed after the ink absorber 13 is provisionally formed, the density distribution is no longer upset. Thereafter, the insertion of the ink absorber 13 in which the density distribution is formed is completed by taking out the ink absorber 13 from the heating container 24 and by inserting the ink absorber into the tank case 12.

### Second Embodiment

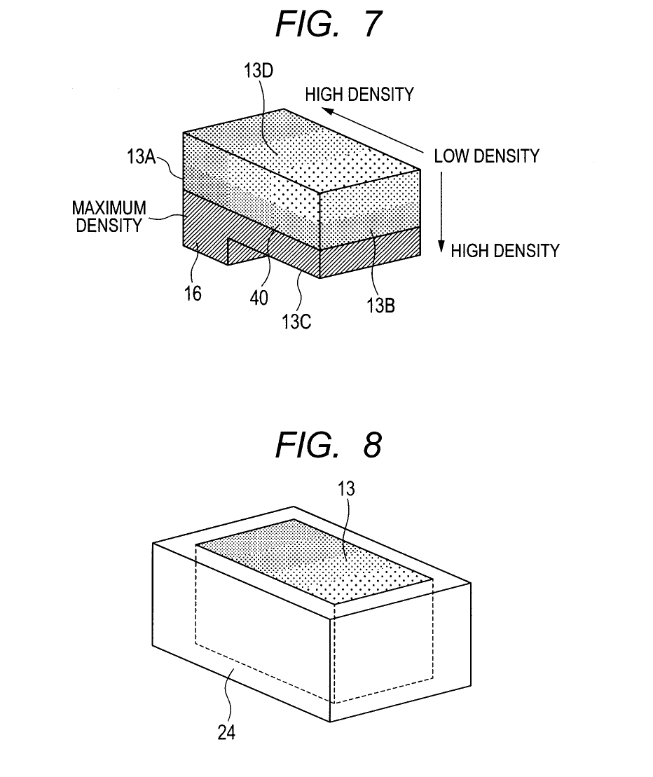

Schematic views of a second embodiment in the manufacturing method of the invention are illustrated in FIGS. 6A and 6B. Similarly to the first embodiment, the ink absorber 13, which is a fiber assembly in which intersections between fibers are not fused together, is charged into the compression and insertion apparatus 18, and the ink absorber 13 is pushed toward the fixing plate 23 in the order of the side plate 19 and the side plate 20. Since the internal volume of the compression and insertion apparatus 18 into which the ink absorber 13 is charged is enlarged in advance, the density distribution is rarely formed simply by moving the all the fibers in the direction of the side plate 20 when the ink absorber has been pushed by the side plate 19. Since the escape space of all the fibers decreases when the ink absorber is further pushed by the side plate 20, the ink absorber is slightly compressed, and the density distribution is slightly formed. Next, the bottom plate 21 is moved up and compression is performed from the bottom face of the ink absorber 13. When this bottom face is finally compressed, the ink absorber is compressed in a state where there is almost no escape space where the whole fibers move. As a result, as illustrated in FIG. 7, in the ink absorber 13, the density on the side of the face 13A corresponding to the side plate 20 near the face 13C on the side of the bottom plate becomes the highest. In contrast, the density near a face 13D corresponding to the insertion block 22 and the density near the face 13B opposite to the face corresponding to the side plate 20 become low. Thereby, the fiber density near the ink supply portion 16 illustrated in FIG. 1B becomes high, and it is consequently possible to draw ink 15 close to the ink supply portion 16. Therefore, the efficiency in the use of the ink 15 improves.

Additionally, as illustrated in FIGS. 6A and 6B, if the ink absorber 13 is once inserted into a heating container 24 after being compressed, and is heated in that state, intersections between fibers in a state where density distribution is formed are fused together. Then, even in case where handling is performed after the ink absorber 13 is provisionally formed, the density distribution is no longer upset. Thereafter, the insertion of the ink absorber 13 in which the density distribution is formed is completed by taking out the ink absorber 13 from the heating container 24 and by inserting the ink absorber into the tank case 12.

### Third Embodiment

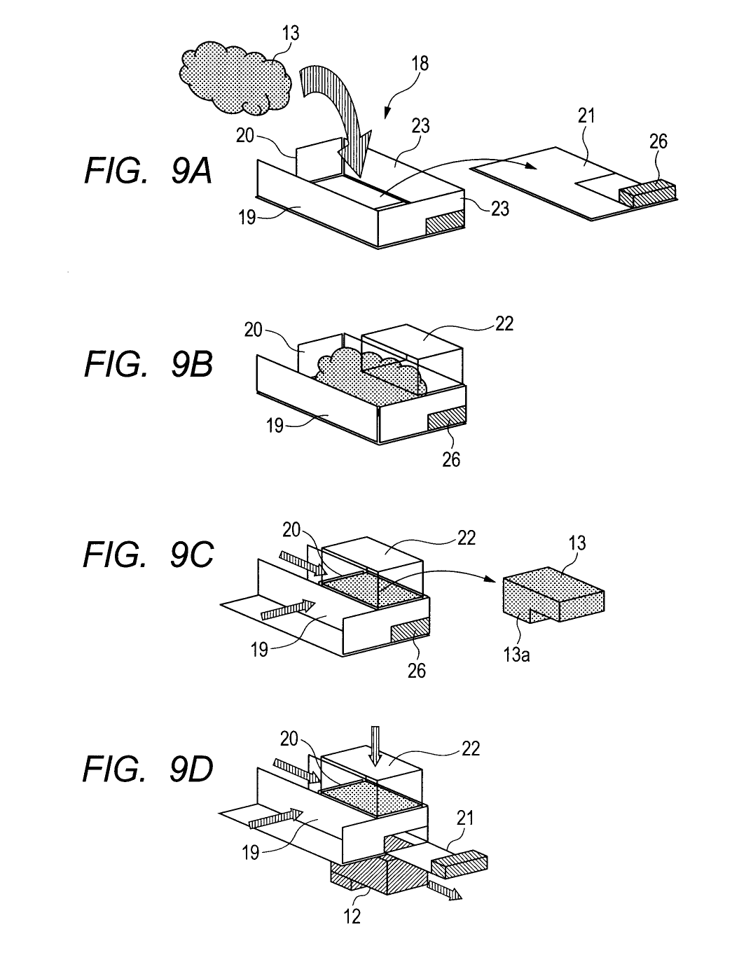

The third embodiment is a manufacturing method in a case where it is intended to make the capillary force of the part of the ink absorber located near the ink supply portion 16 higher. Schematic views of a third embodiment in the manufacturing method of the invention are illustrated in FIGS. 9A to 9D. Similarly to the first embodiment, first, a predetermined amount of the ink absorber 13, which is a fiber assembly in which intersections between fibers are not fused together, is charged into the compression and insertion apparatus 18. Next, as illustrated in FIGS. 9B and 9C, the insertion block 22 is moved to the upper surface portion of the absorber 13, and one face of the ink absorber 13 is pushed by the side plate 19. In the present embodiment, the following method is used during such operation. That is, as illustrated on the right of FIG. 9A, a convex portion 26 is provided in advance at a portion of the bottom plate 21. In other words, as illustrated on the right of FIG. 9C, the convex portion 26 is provided so that a portion 13a corresponding to the ink supply portion of the ink absorber increases, and is adapted to give a level difference after the compression of the ink absorber 13.

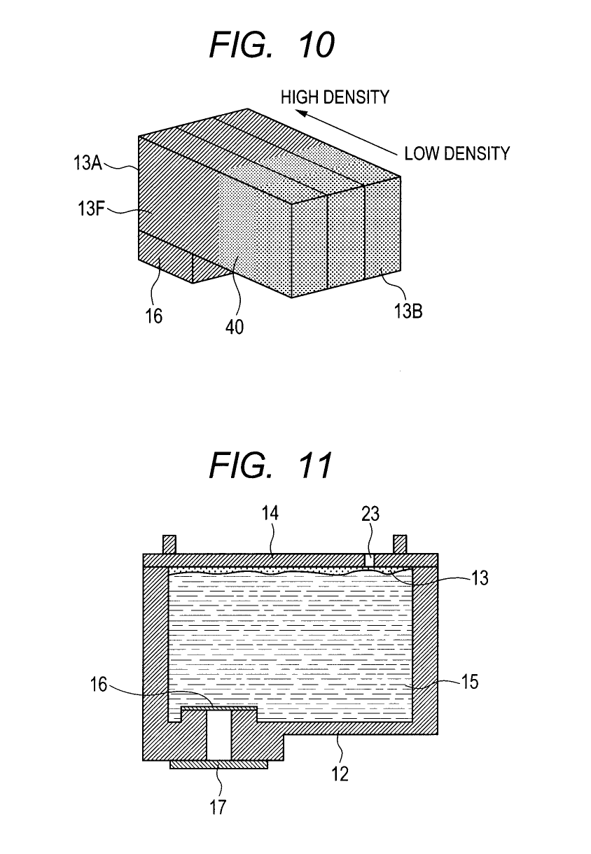

Then, as illustrated in FIG. 9D, the ink absorber 13 is inserted into the tank case 12 by making the bottom plate 21 slide, thereby opening the bottom face of the ink absorber 13 and by moving down the insertion block 22. Since the amount (volume) of the portion of the ink absorber 13 which abuts on the ink supply portion 16 illustrated in FIG. 1B is increased in advance, as illustrated in FIG. 10, it is possible to further increase the density of an ink absorber portion of an upper part 13F of the ink supply portion 16 after the ink absorber is inserted into the tank case 12. Thereby, the fiber density near the ink supply portion 16 illustrated in FIG. 1B becomes higher than the above-described embodiments, and it is possible to draw ink 15 close to the ink supply portion 16. Therefore, the efficiency in the use of the ink 15 improves.

Additionally, as illustrated in FIG. 8, if the ink absorber 13 is once inserted into a heating container after being compressed, and is heated in that state, intersections between fibers in a state where density distribution is formed are fused together. Then, even in case where handling is performed after the ink absorber 13 is provisionally formed, the density distribution is no longer upset. Thereafter, the insertion of the ink absorber 13 in which the density distribution is formed is completed by taking out the ink absorber 13 from the heating container 24 and by inserting the ink absorber into the tank case 12.

### Fourth Embodiment

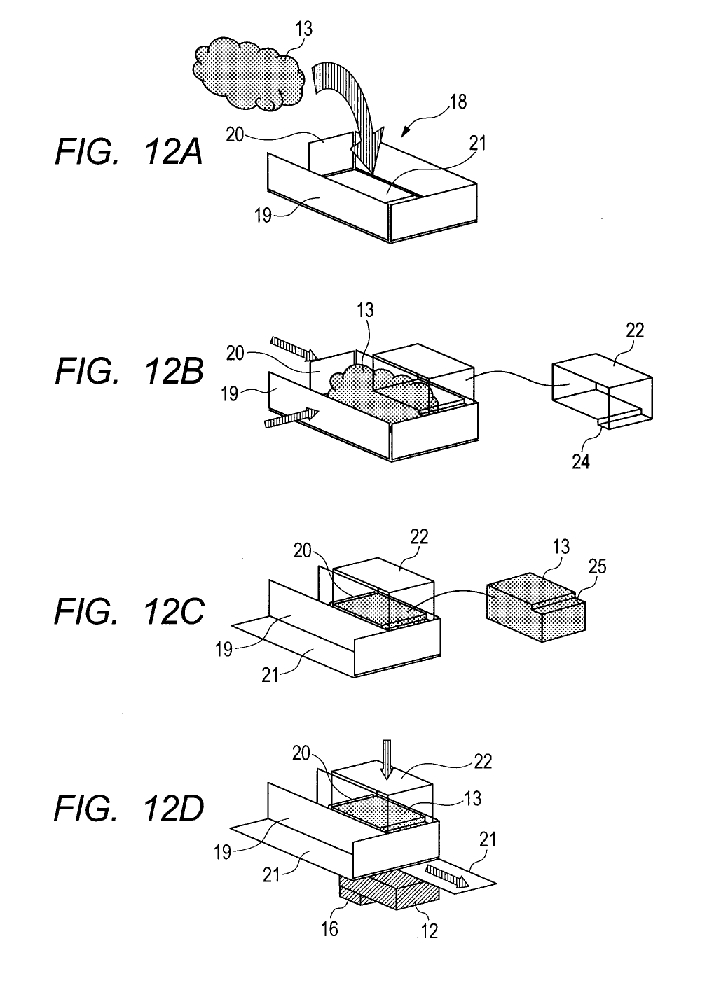

FIG. 11 is a schematic sectional view illustrating an ink jet cartridge manufactured by the manufacturing method of the present embodiment. Schematic views of a fourth embodiment in the manufacturing method of the invention are illustrated in FIGS. 12A to 12D. The present embodiment is an example where an ink cartridge is manufactured in which a lid 14 is provided with an atmosphere communication portion 23 which allows the inside of the tank case 12 to communicate with the atmosphere is provided in the same configuration as the ink jet cartridge illustrated in FIG. 1A. Similarly to the first embodiment, first, as illustrated in FIG. 12A, a predetermined amount of the ink absorber 13, which is a fiber assembly in which intersections between fibers are not fused together, is charged into the compression and insertion apparatus 18. The amount of the ink absorber to be charged is determined depending on a desired negative pressure (fiber density) with respect to the volume or ink injection amount of the tank case 12. Next, as illustrated in FIG. 12B, the ink absorber 13 is compressed by the side plate 19 and the side plate 20 which are compression plates.

At this time, the face of the insertion block 22 which is brought into contact with the ink absorber 13 is provided with a convex portion 24 which protrudes more than other portions, and the shape of the ink absorber 13 after compression becomes as illustrated in the right view of FIG. 12C due to this convex shape. Next, as illustrated in FIG. 12D, insertion of the ink absorber 13 into the tank case 12 is completed by making the bottom plate 21 slide, thereby opening the bottom face of the ink absorber 13 and by further moving down the insertion block 22.

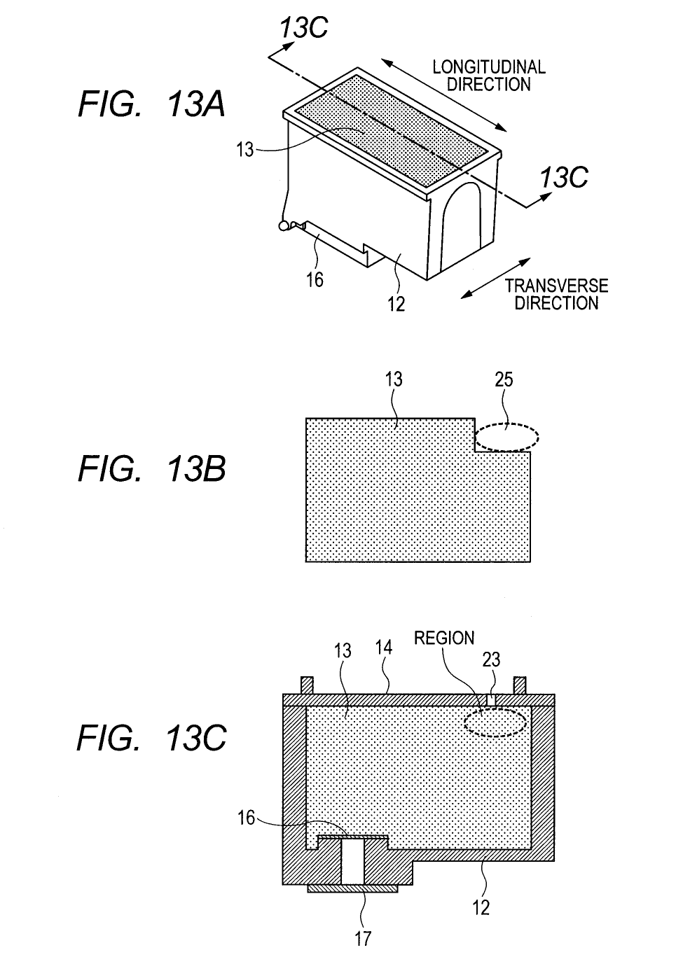

If the above step is described in more detail, as illustrated in FIG. 13B, a recess 25 is formed as a provisionally molded shape of the ink absorber 13 before the ink absorber is inserted into the ink storage portion, and this provisionally molded shape is smaller than the inside dimension of the ink storage portion. However, since the ink absorber is an ink absorber in which fibers are not bonded together, the fibers are moved due to the restoring force of the fibers after insertion into the ink storage portion, a shape is obtained in which the inside of the tank case 12 as illustrated in FIG. 13C which is a sectional view taken along the line 13C-13C of FIG. 13A is filled.

The restoring force of this fiber is determined by the fiber density, fiber material, fiber diameter, or fiber length within the tank case 12 which have been earlier described. These are appropriately selectable from the shape of the recess 25 at the time of provisional molding. Additionally, the shape of this recess 25 may be determined in accordance with a desired capillary force. By inserting the ink absorber 13 in which the recess 25 has been provisionally molded into the tank case 12 in this way, the fiber density of a region immediately below the atmosphere communication portion 23 becomes low, and consequently, the capillary force becomes small. Therefore, ink hardly moves to the vicinity of the atmosphere communication portion 23, and it is consequently possible to reduce ink leakage from the atmosphere communication portion 23. Additionally, since the insertion block 22 functions as both the compression plate at the time of provisional molding and a push member at the time of insertion, it is possible to immediately insert the ink absorber 13 into the ink storage portion after the completion of the provisional molding. Therefore, there is no necessity for handling the ink absorber 13 between the provisional molding step and the inserting step, and the density distribution is not upset.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-041735, filed Feb. 26, 2010, which is hereby incorporated by reference herein in its entirety.

What is claimed is:

1. A method for manufacturing an ink jet cartridge in which an ink absorber consisting of an assembly of the fibers which are not fused to each other and holding ink therein by the capillary force between fibers is housed in an ink storage portion which stores ink to be supplied to an ink discharge device which discharges ink, the method comprising:
compressing the ink absorber to provisionally mold the ink absorber; and
inserting the compressed ink absorber into the ink storage portion,
wherein the provisional molding compresses and surrounds a surface excluding a surface on the side of the part of the ink absorber where the capillary force is to be increased, using a compression plate, and finally compresses the surface on the side of the part of the ink absorber where the capillary force is to be increased, using a separate compression plate in the compressed and surrounded state.

2. The method of an ink jet cartridge according to claim 1,
wherein an ink absorber portion corresponding to the vicinity of an ink supply portion of the ink storage portion which supplies ink to the ink discharge device is finally compressed in the provisional molding.

3. The method of an ink jet cartridge according to claim 1,
wherein an ink absorber portion which abuts on an ink supply portion of the ink storage portion which supplies ink to the ink discharge device is finally compressed in the provisional molding.

4. The method of an ink jet cartridge according to claim 1,
wherein in the provisional molding, the ink absorber is compressed and provisionally molded so as to have a convex shape in which the part of the ink absorber where the capillary force is to be increased is protruded more than other parts.

5. The method of an ink jet cartridge according to claim 1,
wherein in the provisional molding, the ink absorber is compressed and provisionally molded so as to have a convex shape in which the portion of the ink absorber corresponding to the vicinity of an ink supply portion of the ink storage portion which supplies ink to the ink discharge device is protruded more than other ink absorber portions.

6. The method of an ink jet cartridge according to claim 1,
wherein the ink absorber is heated in a state where the density distribution of the provisionally molded ink absorber is maintained after the ink absorber is provisionally molded, and intersections between the fibers are fused together.

7. The method of an ink jet cartridge according to claim 1,
wherein the ink absorber that has a portion smaller than the inside dimension of the ink storage portion is molded in the provisional molding.

8. The method of an ink jet cartridge according to claim 7,
wherein the ink jet cartridge is provided with an atmosphere communication portion which allows the ink absorber filled into the inside of the ink storage portion to communicate with the atmosphere, and the shape of the ink absorber at the time of provisional molding is such that the portion which comes into the vicinity of the atmosphere communication portion after insertion of the ink absorber into the ink storage portion is smaller than the inside dimension of the ink storage portion.

9. The method of an ink jet cartridge according to claim 1, wherein one of the compression plates has a function to insert the provisionally molded ink absorber into the ink storage portionink storage portion.
